(19) United States
(12) Patent Application Publication
(10) Pub. No.: US 2016/0188092 A1
(43) Pub. Date: Jun. 30, 2016

(54) TOUCHSCREEN ANTENNA SYSTEM AND DESIGN METHOD THEREOF

(71) Applicant: PaneraTech, Inc., Chantilly, VA (US)

(72) Inventors: Tom Sebastian, Fairfax City, VA (US); Yakup Bayram, Falls Church, VA (US)

(21) Appl. No.: 14/976,365

(22) Filed: Dec. 21, 2015

Related U.S. Application Data
(60) Provisional application No. 62/095,479, filed on Dec. 22, 2014.

(51) Int. Cl. G06F 3/041; H01Q 1/22; G06F 3/043; G06F 3/044; G06F 3/045

(52) U.S. Cl. CPC G06F 3/0416; G06F 3/044; G06F 3/045; G06F 3/043; G06F 3/0414; H01Q 1/2258

(57) ABSTRACT

Disclosed is a touchscreen antenna system and a method of designing a touchscreen antenna system. The system and method are operative to integrate an antenna with one or more touchscreen components to render a compact and effective system and to provide a more robust operation. The system is configured such that an antenna element, comprising a radiating component or an antenna feeding portion, is electromagnetically coupled to a touchscreen element, including a touch sensor, a touch sensor line, and other active or passive elements of a touchscreen module. Accordingly, the system is capable to mitigate adverse effects, when operating in an environment or under conditions that may affect other systems or be susceptible to being affected by other sources, by designing antenna and touchscreen elements as an integrated unit. Additionally, the system and method provide an enhanced antenna system performance by incorporating touchscreen elements as part of the antenna design.

### CROSS REFERENCE TO RELATED APPLICATION

This application is based upon and claims priority from co-pending U.S. Provisional Patent Application Ser. No. 62/095,479 entitled “TOUCHSCREEN ANTENNA SYSTEM AND DESIGN METHOD THEREOF” filed with the U.S. Patent and Trademark Office on Dec. 22, 2014, by the inventors herein, the specification of which is incorporated herein by reference.

### FIELD OF THE INVENTION

The present invention relates to antenna systems and methods. More particularly, the present invention relates to antenna systems and to antenna design and manufacturing methods for integrating antennas with touchscreen systems.

### BACKGROUND OF THE INVENTION

A number of antenna designs and systems exist within various industries for enabling communications of a touchscreen module at several frequency bands for multiple applications. More specifically, nowadays touchscreen modules may require antennas for Wireless Fidelity (Wi-Fi), Bluetooth, Radio Frequency (RF) identification, near-field communications, and other applications.

In general, one or more antennas are installed in a touchscreen module. Accordingly, aesthetic issues may arise resulting from the antenna form factor. Thus, the integration of antennas with a touchscreen module have been actively demanded by users. However, integrating an antenna with a touchscreen module brings a number of other issues, such as antenna frequency detuning, RF interference to and from other touchscreen elements, and more importantly, antenna and system degradation performance. This is primarily due to the large number of electrically conductive components present in a touchscreen, including touch sensors, touch sensing lines, electrodes, display, integrated circuits, controllers, transmission lines, etc., that may affect the operational performance of the antenna.

This situation becomes more critical for touchscreen antenna applications used in portable and handheld electronic devices because of the small size of these units. In recent years, the demand for touchscreen modules requiring antennas has increasingly grown for applications in the computer, mobile platform, and automobile industries. In particular, the implementation of a touchscreen having an antenna integrated has been addressed in the prior art, as described in U.S. Pat. App. No. 20110273382 to Yoo et al. However, these efforts have faced certain challenges and limitations. Specifically, the antenna has been integrated by forming an antenna pattern in the inactive region of one or more of the touchscreen substrates. A major challenge is that the space available in the inactive region is limited to a small area around the edges of these substrates, constraining the size and type of antennas to be used. In addition, antennas are susceptible to being detuned or blocked by the presence of surrounding extraneous materials, unless the antenna is enclosed in a separate module making it bigger and more expensive.

Likewise, multiple antenna elements are needed to be able to operate at different frequency bands, which make the size requirements significantly larger and the need to use a bigger number of or more complex electronic components, resulting in higher costs. Previous efforts also include enabling the formation of all or respective portions of a touch sensor and an antenna during the same process to reduce manufacturing costs, as described in U.S. Pat. App. No. 20140176819 to Yilmaz. However, these efforts still do not solve the space and performance limitations resulting from undesired effects between touchscreen elements and antenna elements.

More specifically, a major constraint may result where the antenna receives spurious signals from nearby sources, especially within the touchscreen module, that increase the noise level of the system. Another limitation may result where the antenna radiates spurious signals that may interfere with other internal and external electronic systems. These limitations may compromise the signal integrity of internal and/or external systems or make it very challenging for a touchscreen antenna to meet signal integrity industry standards.

A way to address the disadvantages of the efforts attempted by the prior art is to design a touchscreen antenna system that operatively integrates a touchscreen element with an antenna element. This would make it possible to enhance the performance and increase the robustness of the overall antenna system while mitigating or eliminating undesired effects, by configuring the touchscreen element to function as a part of the touchscreen antenna system. In particular, a configuration may be designed to integrate an antenna element, a touchscreen element, a feeding mechanism and a corresponding transmission line in a single unit for additional advantages, such as more compactness, lower manufacturing costs, and potential higher signal integrity.

Currently, there is no well-established method of deterministically creating a touchscreen antenna system that combines antenna elements and touchscreen elements to operate as an integrated antenna unit, over one or more frequency bands of interests, preventing undesired effects between each other and effectively withstanding performance degradation under operational conditions.

Thus, there remains a need in the art for touchscreen antenna systems and methods to design such systems that are capable of a robust operation at the frequencies of intended applications, while avoiding the problems of prior art systems and methods.

### SUMMARY OF THE INVENTION

A touchscreen antenna system and a method of designing a touchscreen antenna system are disclosed herein. One or more aspects of exemplary embodiments provide advantages while avoiding disadvantages of the prior art. The system and method are operative to integrate an antenna with one or more touchscreen components to render a compact and effective system and to provide a more robust operation. The system is configured such that an antenna element, comprising a radiating component or an antenna feeding portion, is electromagnetically coupled to a touchscreen element, including a touch sensor, a touch sensor line, a display unit, a touch controller, and other active or passive elements of a touchscreen module. Accordingly, the system is capable to mitigate adverse effects, when operating in an environment or under conditions that may affect other systems or be susceptible to being affected by other sources, by designing antenna and touchscreen elements as an integrated unit. Additionally, the system and method provide an enhanced antenna system performance by incorporating touchscreen elements as part of the antenna design.

In general, an antenna may be detuned or offset in frequency under certain operational conditions, such as the presence of any combination of user body parts (e.g., hands, fingers, head or other parts of the body as when such device is placed in a pocket or hung on clothing), conductive materials, or dielectric materials located within a radius of two wavelengths at the lowest frequency of operation in the medium where the antenna element is operating. Particularly, an antenna element integrated within a touchscreen module may be particularly susceptible to frequency detuning. Interference to and from other sources may also present a challenge to the operational performance of such antenna.

However, by designing a touchscreen antenna system to comprise an antenna element in combination with a touchscreen element it is possible to effectively and efficiently implement an antenna system having an improved performance. Primarily, an antenna element may comprise an active radiation element, a passive radiation element, and an antenna feeding element. Likewise, a touchscreen element may include an active touchscreen element, a passive touchscreen element, and a touch sensor line. The key aspect is to follow an integrated design approach by which the touchscreen element operatively becomes a part of the antenna system by physically and/or capacitively coupling to an antenna element to operate together as an integrated unit.

A touchscreen antenna system designed according to the method described herein is able to meet these requirements by using a touchscreen element as at least a portion of a radiating element, a parasitic element, or a feeding mechanism to adapt the performance of an antenna element to the actual specifications of the intended applications. In addition, this adaptation may take into consideration the input impedance matching between the antenna element and the transmission line feeding the antenna, which is also a key factor impacting the overall performance of the touchscreen antenna system.

The method to design a touchscreen antenna system to mitigate adverse effects when operating in a potentially antenna-detuning environment or under conditions that may interfere with other systems or be susceptible to interference from other sources, and for setting up the antenna system dimensional and operational parameters includes the step of determining a location of an antenna element and a feeding mechanism to feed such antenna element within a touchscreen module.

The method further includes the steps of identifying key operational conditions in which the performance of the antenna element might be affected. These key operational conditions may include, but are not limited to, the presence of any combination of human user body parts (e.g. hands, fingers, head or other parts of the body as when such device is placed in a pocket or hung on clothing), conductive materials, or dielectric materials located within a radius of two wavelengths at the lowest frequency of operation in the medium where said antenna element is operating.

The method further includes the steps of enhancing such performance by designing one or more antenna elements combined with one or more touchscreen elements to operate integrated as a single antenna system configuration. Accordingly the method allows to design a suitable touchscreen antenna system to be used for the intended application, in terms of performance or other predetermined criteria.

By significantly adapting the performance of an antenna element by means of integrating a touchscreen element with such antenna element, the touchscreen antenna system and method are able to provide a robust design against frequency detuning, at the frequencies of intended operation, and a significant reduction of undesired effects at frequencies of no operational interest, as compared to designs using standard techniques. This results in touchscreen antenna designs that meet or exceed challenging industry standards, in terms of antenna performance and signal integrity of both internal and external systems.

### BRIEF DESCRIPTION OF THE DRAWINGS

FIG. 1 shows a top view of a touchscreen antenna system integrating a feeding mechanism with a passive element of a touchscreen;

FIG. 2 shows a top view of a touchscreen antenna system integrating an adaptive feeding mechanism with an active element of a touchscreen;

FIG. 3 shows a top view of a touchscreen antenna system fed by using a touch sensor line;

FIGS. 4A and 4B show exploded, perspective views of various aspects of a touchscreen antenna system integrating a substrate layer and an antenna fed by a feeding mechanism within the touchscreen module;

FIGS. 5A and 5B show various aspects of a touchscreen antenna system integrating a substrate layer and an antenna with other components of a touchscreen module; and

FIG. 6 shows a schematic view of a method for designing a touchscreen antenna system.

### DETAILED DESCRIPTION OF THE PREFERRED EMBODIMENTS

The following description is of one or more aspects of the invention, set out to enable one to practice an implementation of the invention, and is not intended to limit the invention to any specific embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

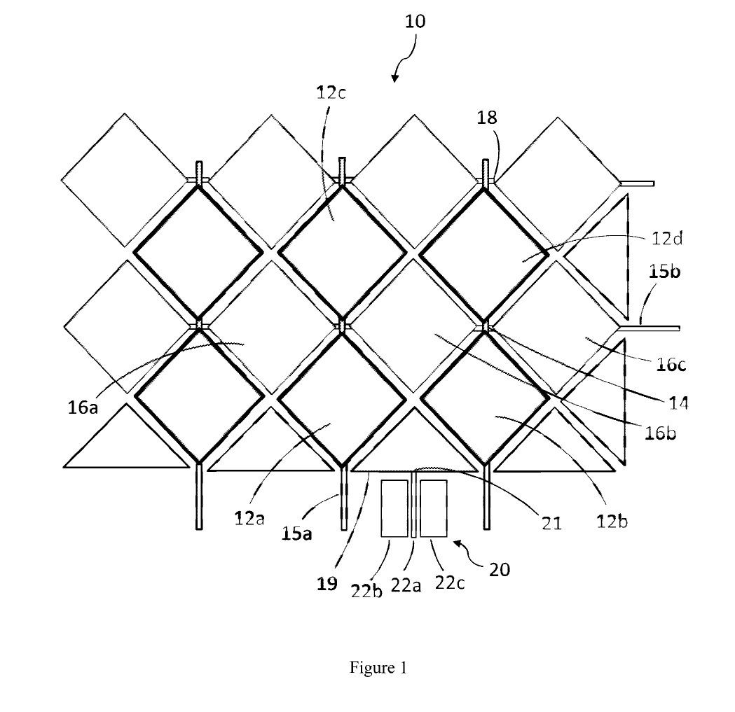

FIG. 1 shows a top view of an exemplary configuration of a touchscreen antenna system 10, integrated with a typical touchscreen having two layers of touch sensors or active touchscreen elements or electrodes, each sensor having a shape of a parallelogram. A first set of sensors 12a, 12b, 12c, and 12d are disposed on a first substrate layer (X layer) in a row-column matrix arrangement, wherein the sensors in the same column are physically and electrically connected to each other by a connecting section 14. The sensors in different columns are not physically connected to each other. Connecting section 14 allows to electrically connect two adjacent sensors in the same column to a touch sensor line 15a used to determine the location of a touch on the X layer.

Likewise, a second set of sensors 16a, 16b, and 16c are disposed on a second substrate layer (Y layer) in a row-column matrix arrangement, wherein the sensors in the same row are physically and electrically connected to each other by a connecting section 18. The sensors in different rows are not physically connected to each other. Connecting section 18 allows to electrically connect two adjacent sensors in the same row to a touch sensor line 15b used to determine the location of a touch on the Y layer.

The first substrate layer, X layer, and the second substrate layer, Y layer, are separated, and electrically isolated, from each other by an interposed insulating layer. Typically, all sensors, connecting sections between sensors, and touch sensor lines are made of a transparent, conductive layer of a material such as Indium tin-oxide (ITO). In addition, the insulating layer, the first substrate layer, and the second substrate layer are disposed on an optically transparent substrate layer.

The first set of sensors on the X layer and the second set of sensors on the Y layer are interleaved in a manner such that from a top view, the space among any four adjacent sensors on layer X, arranged in a 2-row by 2-column pattern, is occupied by a sensor on layer Y. For instance, the space among sensors 12a, 12b, 12c, and 12d is occupied by sensor 16b. Likewise, the space among any four adjacent sensors on layer Y, arranged in a 2-row by 2-column pattern, is occupied by a sensor on layer X.

Furthermore, a set of touchscreen passive elements or dummy sensors 19, each having a triangular shape, is typically disposed on the edges of the X layer and or the Y layer to improve visual homogeneity and transparency of the touchscreen, by filling the space in between the active touchscreen sensors closer to the edges of the touchscreen and the edges of the touchscreen. Typically, touchscreen passive element 19 is made of the same material, such as ITO, used to make the active touchscreen sensors and is not physically connected to any other sensor or component.

Touchscreen antenna system 10 comprises a feeding mechanism 20 integrated with touchscreen passive element 19. Feeding mechanism 20 is coupled to touchscreen passive element 19 by means of a physical connection or by means of a capacitive coupling at feeding point 21. Furthermore, touchscreen passive element 19 is capacitively coupled to touchscreen active elements 12a and 12b. Moreover, touchscreen active element 12a is electrically connected to touchscreen active element 12c and capacitively coupled to touchscreen passive elements 16a and 16b. Similarly, touchscreen active element 12b is electrically connected to touchscreen active element 12d and capacitively coupled to touchscreen passive elements 16b and 16c.

In addition, touchscreen passive element 19 may also capacitively couple in a lesser degree to touchscreen active element 16b and other touchscreen passive elements. As a result, touchscreen antenna system 10 effectively becomes an antenna array comprising touchscreen passive elements, touchscreen active elements, and touch sensor lines of the touchscreen. In other words, touchscreen antenna system 10 utilizes the touch sensors and touch sensor lines as radiating elements.

In this configuration, feeding mechanism 20 comprises a coplanar waveguide formed by a center line 22a, having a rectangular shape and made of conductive material having a 1-mm width, and a ground plane formed by two rectangular sections of conductive material 22b and 22c, each disposed coplanar, in close proximity, and substantially parallel to center line 22a, as well known to those skilled in the art. Sections 22b and 22c have preferably similar size and are separated by a distance ranging from 0.25 mm to 5 mm from touchscreen passive element 19. Center line 22a is electrically connected to touchscreen passive element 19 at feed point 21.

Moreover, a portion of feeding mechanism 20 may be disposed on a flexible substrate and be a part of a flexible printed circuit (FPC) or may be planar with touchscreen passive element 19. In general, the dimensions of sensors 12a to 12d and 16a to 16c range from 3-mm by 3-mm to 30-mm by 30-mm, depending on the size and specific application of a touchscreen. Preferably, the dimensions of touchscreen passive element 19 correspond to those of a triangle formed by bisecting the parallelogram shape of one of the sensors 12a to 12d or 16a to 16c through two opposite vertices. Typically, the spacing between adjacent sensors, such as sensor 12a and sensor 16a and sensor 12a and sensor 19, is equal or less than 1 mm.

A location of feed point 21 may be selected to excite a certain current density distribution on touchscreen passive element 19. Additionally, the size and shape of touchscreen passive element 19 may be configured to increase or decrease the capacitive coupling to surrounding touchscreen elements. Thus, based on a specific configuration, dimensions, and excitation current of touchscreen passive element 19, touchscreen antenna system 10 may be designed for a specific application. In particular, touch sensor lines 15a and 15b do not electromagnetically interfere with touchscreen antenna system 10 because touch sensor lines 15a and 15b typically operate at substantially lower frequencies, within a frequency range such as 100 KHz to 1 MHz, as compared to the frequencies of operation of suitable applications of touchscreen antenna system 10, which include the Near Field Communications band, operating at around 13.56 MHz and other applications usually operating at or higher than 500 MHz.

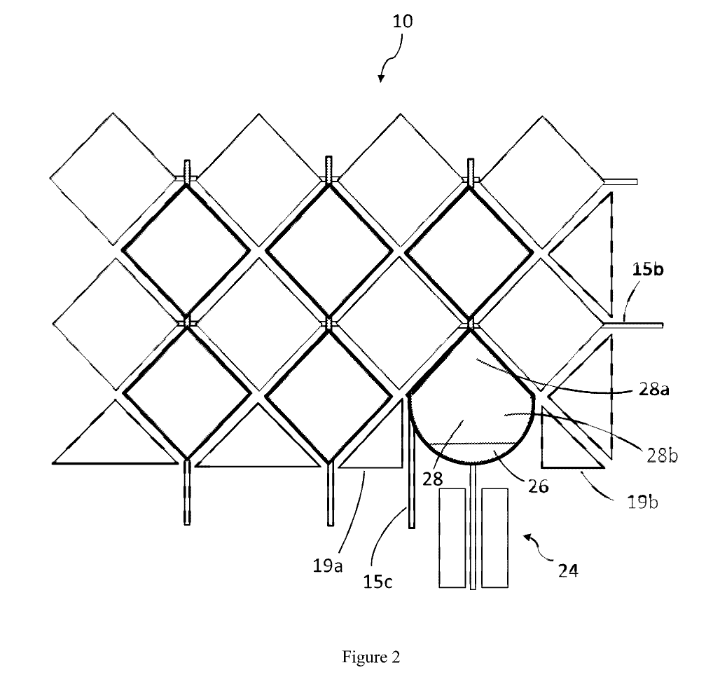

FIG. 2 shows a top view of an alternative exemplary configuration of touchscreen antenna system 10 integrated with a typical touchscreen, having two layers of touch sensors or active touchscreen elements arranged similarly to the touch sensors shown in FIG. 1. In this configuration, a feeding mechanism 24, made of conductive material and comprising a coplanar stripline, as shown in FIG. 1, and an adaptive feeding section 26, is integrated with a touch sensor 28. In particular, touch sensor 28 is positioned next to an edge of the touchscreen and does not have the typical configuration of a parallelogram. Instead, touch sensor 28 is configured to have a first triangular section 28a, opposite feeding section 26, and a second semi-elliptical section 28b operatively coupled to feeding section 26.

More specifically, section 28a transitions smoothly from a triangular shape into the semi-elliptical shape of section 28b to allow a more uniform current density distribution on section 28 for better performance of touchscreen antenna system 10. Preferably sections 28a and 28b are made of a transparent, conductive layer of a material such as ITO. More preferably, sections 28a and 28b form a single unit. Alternatively, due to manufacturing considerations, section 28a may be part of a parallelogram, and section 28b may be disposed on top of an area of such parallelogram, not overlapping section 28a, resulting in the configuration of sensor 28 shown in FIG. 2.

Preferably, adaptive feeding section 26 is made of conductive material and has a semi-elliptical shape that defines an area smaller than the area defined by the semi-elliptical shape of section 28b. More preferably, the curved edge of semi-elliptical feeding section 26 adaptively aligns with the curved edge of semi-elliptical section 28b, such that section 28b fully overlaps feeding section 26. This configuration allows a more uniform current density distribution on section 28 for better performance of touchscreen antenna system 10.

In this embodiment, touchscreen antenna system 10 comprises feeding mechanism 24 integrated with touch sensor 28. Feeding section 26 is coupled to touch sensor 28 by means of a physical connection or by means of a capacitive coupling with section 28b. Furthermore, touch sensor 28 is capacitively coupled or electrically connected to either touchscreen passive elements or other touch sensors. As a result, touchscreen antenna system 10 effectively becomes an antenna array comprising touchscreen passive elements, touchscreen active elements, and touch sensor lines of the touchscreen.

Furthermore, the semi-elliptical shape of section 28b may require touchscreen passive elements 19a and 19b, adjacent to touch sensor 28, to be resized or configured differently to the typical triangular shape to avoid overlapping and to meet the visual homogeneity and transparency requirements of the touchscreen. In particular, touch sensor lines 15a and 15b do not electromagnetically interfere with touchscreen antenna system 10 because touch sensor lines 15a and 15b typically operate at substantially lower frequencies, within a frequency range such as 100 KHz to 1 MHz, as compared to the frequencies of operation of suitable applications of touchscreen antenna system 10, which include the Near Field Communications band, operating at around 13.56 MHz and other applications usually operating at or higher than 500 MHz.

Moreover, in this configuration, feeding section 26 is preferably positioned at the middle region of the curved edge of section 28b. This positioning of feeding section 26 may require repositioning touch sensor line 15c to one side of touch sensor 28 in order to touch sensor 28 without physically interfering with feeding mechanism 24. Additionally, a portion of feeding mechanism 24 may be disposed on a flexible substrate and be a part of a flexible printed circuit (FPC) or may be planar with touch sensor 28.

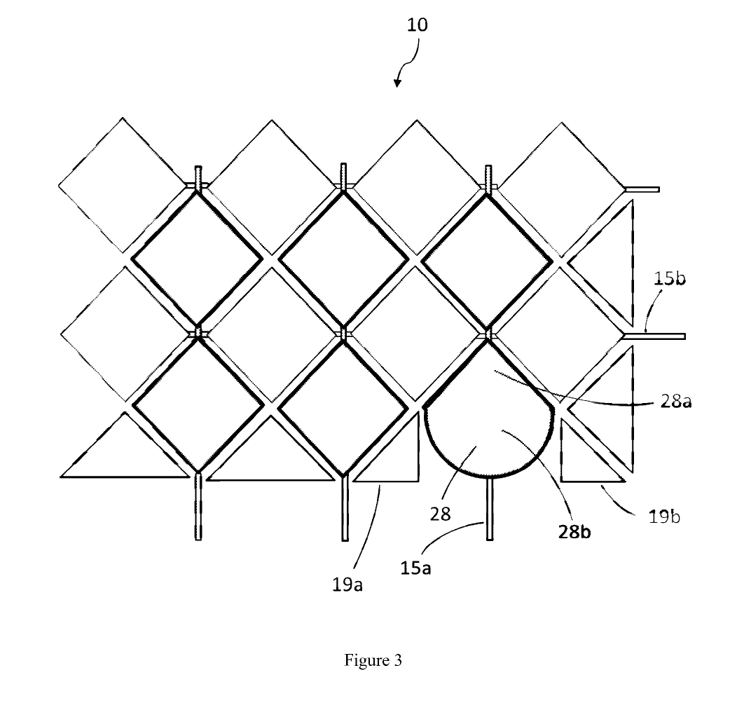

In yet another exemplary configuration, FIG. 3 shows a top view of touchscreen antenna system 10 fed by using a touch sensor line 15a, having two layers of touch sensors or active touchscreen elements arranged similarly to the touch sensors shown in FIG. 2. In this configuration, touch sensor 28 is positioned next to an edge of the touchscreen and is operatively connected to touch sensor line 15a, such that touch sensor line 15a operates both to determine the location of a touch on the X layer of the touchscreen and to feed touchscreen antenna system 10.

Likewise, touch sensor 28 is configured to have a first triangular section 28a, opposite touch sensor line 15a, and a second semi-elliptical section 28b operatively connected to touch sensor line 15a, including by means of a physical connection or by means of capacitive coupling.

More specifically, section 28a transitions smoothly from a triangular shape into the semi-elliptical shape of section 28b to allow a more uniform current density distribution on section 28 for better performance of touchscreen antenna system 10. Preferably, touch sensor 28 and touch sensor line 15a form a single unit. Alternatively, due to manufacturing considerations, touch sensor line 15a may be disposed on top of or contiguous to touch sensor 28.

In this embodiment, touchscreen antenna 10 comprises touch sensor line 15a integrated with touch sensor 28. Furthermore, touch sensor 28 is capacitively coupled or electrically connected to either touchscreen passive elements or other touch sensors. As a result, touchscreen antenna system 10 effectively becomes an antenna array comprising touchscreen passive elements, touchscreen active elements, and touch sensor lines of the touchscreen.

Furthermore, the semi-elliptical shape of section 28b may require touchscreen passive elements 19a and 19b, adjacent to touch sensor 28, to be resized or configured differently to the typical triangular shape to avoid overlapping and meet the visual homogeneity and transparency requirements of the touchscreen. In particular, touch sensor lines 15a and 15b do not electromagnetically interfere with touchscreen antenna system 10 because touch sensor lines 15a and 15b operate at substantially lower frequencies as compared to the frequencies of operation of suitable applications of touchscreen antenna system 10.

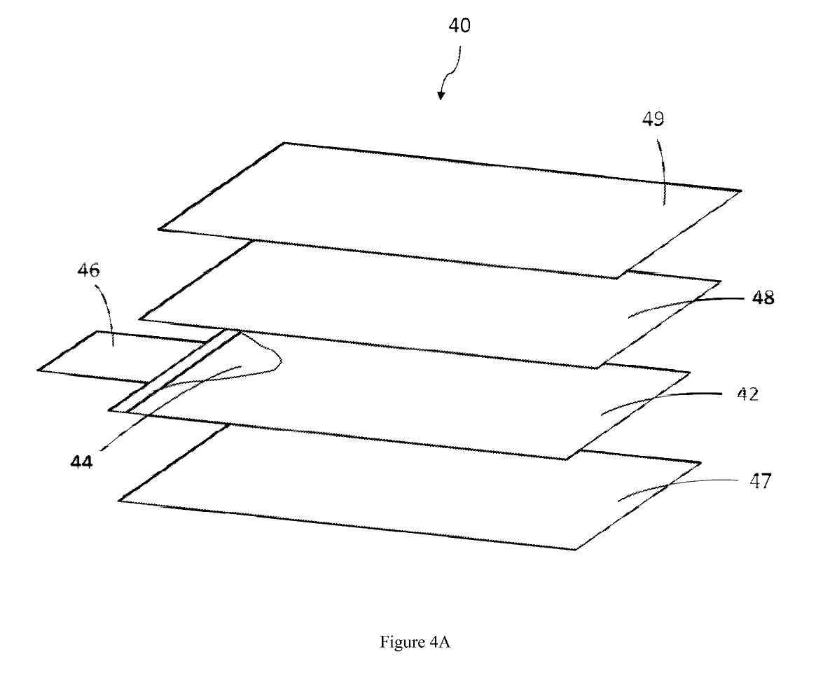

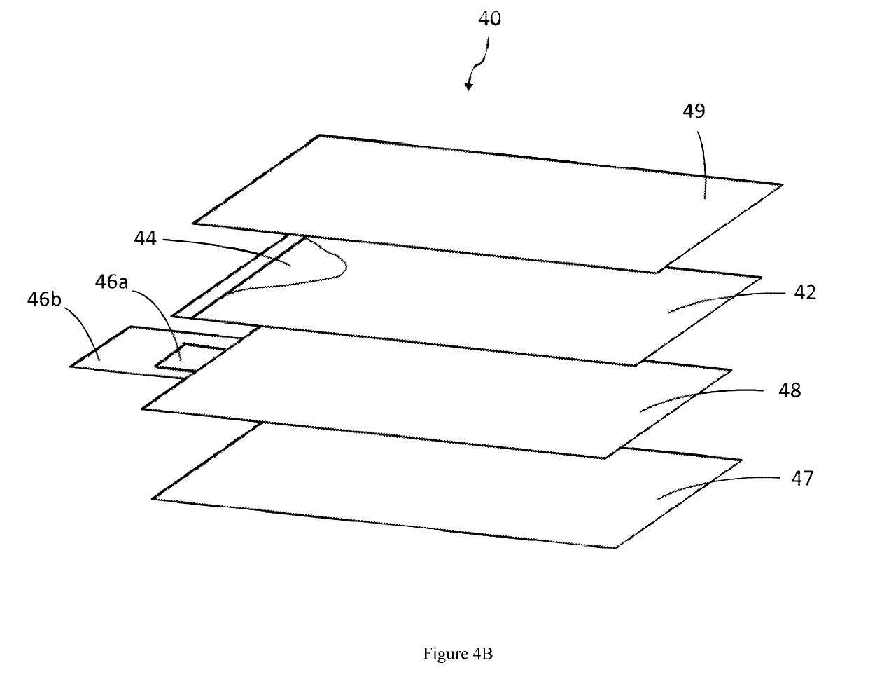

FIGS. 4A and 4B show exploded, perspective views of various aspects of a touchscreen antenna system 40 integrating a substrate layer and an antenna fed by a feeding mechanism within the touchscreen module. In particular, FIG. 4A shows an exploded, perspective view of touchscreen antenna system 40 integrating a substrate layer 42 and an antenna 44 fed by a feeding mechanism 46 within touchscreen antenna system 40. Typically, touchscreen antenna system 40 comprises a substantially flat display unit 47, a touch sensing unit 48, and a protective layer 49.

In general, flat display unit 47 comprises a layer of a substantially conductive material, acting as a ground plane and opposite touch sensing unit 48, and may consist or be a part of a liquid crystal display (LCD). As previously described, touch sensing unit 48 typically comprises two layers of optically transparent touch sensors, electrically isolated from each other by an interposed transparent insulating layer, and disposed on an optically transparent substrate layer. Protective layer 49 consists of a transparent thin layer of a substrate such as glass or plastic.

In this configuration, antenna 44 is disposed on substrate layer 42 integrated as an additional layer within touchscreen antenna system 40. Substrate layer 42 typically consists of a thin film made of optically transparent material, including a polyester film such as polyethylene terephthalate (PET) and a cyclo olefin polymer (COP) material.

Antenna 44 operates in combination with the ground plane of display unit 47 and may capacitively couple to touch sensing unit 48. More specifically, the disposition of substrate layer 42 may be ultimately decided based on the design configuration of antenna 44 and a level of interaction of antenna 44 with display unit 47, touch sensing unit 48, and protective layer 49.

Furthermore, feeding mechanism 46 preferably connects physically to antenna 44 to feed antenna 44. Alternatively, a connection between antenna 44 and feeding mechanism 46 may be implemented by means of capacitive coupling. In addition, feeding mechanism 46 is also preferably implemented, at least partly, on a dedicated flexible printed circuit. However, antenna 44 may also be partly integrated with feeding mechanism 46. More preferably, antenna 44 is planar and made of a transparent, conductive layer of a material such as ITO. Alternatively, antenna 44 may be implemented using a conductive material, including a copper mesh and silver nanowires arranged in a linear or a grid pattern to maintain a required optical transparency of antenna 44.

Specifically, FIG. 4B shows an exploded, perspective view of another exemplary configuration of touchscreen antenna system 40 integrating a feeding mechanism 46a, disposed on touch sensing unit 48, with antenna 44, disposed on substrate layer 42, such that feeding mechanism 46a feeds antenna 44 by means of a capacitive coupling. In this alternate configuration, substrate layer 42 is disposed in between touch sensing unit 48 and protective layer 49. Preferably, antenna feeding mechanism 46a is at least partly disposed on a substrate 46b comprising circuit elements operatively connected to touch sensing unit 48.

Likewise, antenna 44, disposed on substrate layer 42, operates in combination with feeding mechanism 46a, disposed on a layer other than substrate layer 42; the ground plane of display unit 47; and touch sensing unit 48. More specifically, the disposition of substrate layer 42 may be ultimately decided based on the design configuration of antenna 44 and a level of interaction of antenna 44 with display unit 47, touch sensing unit 48, and protective layer 49.

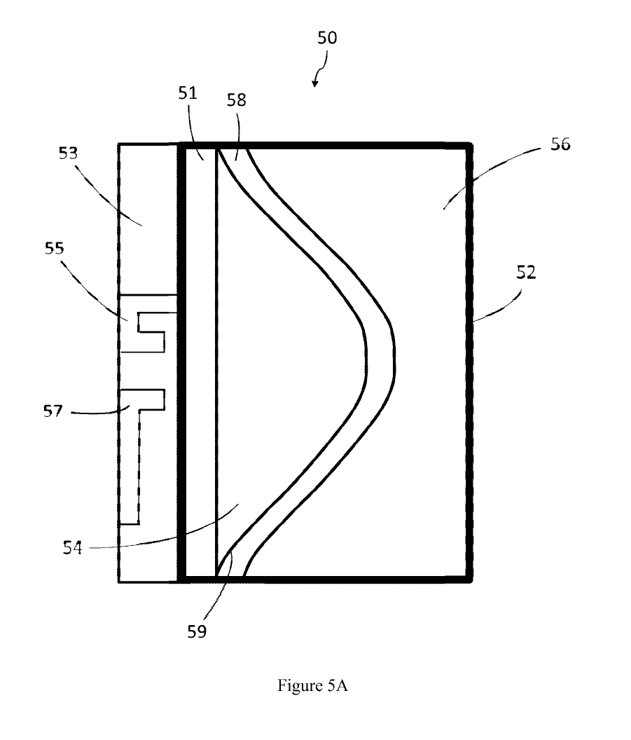

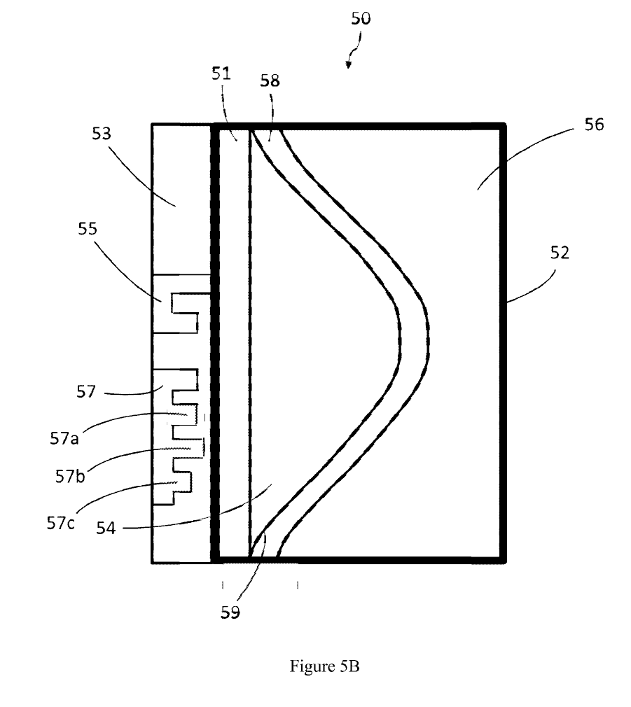

In another configuration, FIGS. 5A and 5B show various aspects of a touchscreen antenna system 50 integrating a substrate layer and an antenna with other components of a touchscreen module. Specifically, FIG. 5A shows a top view of touchscreen antenna system 50, comprising a portion of a substrate layer 52 of a touchscreen. A first region of a transparent conductive material 54 and a second region of a transparent conductive material 56 are disposed on substrate layer 52. Regions 54 and 56 are in close proximity, but not in physical contact, separated by a gap 58. Preferably, regions 54, 56 and gap 58 are formed by cutting out, etching, or deleting an area of material from a rectangular piece of transparent conductive material disposed on layer 52.

Region 54 is configured to perform as an active radiating antenna element and electromagnetically couples to region 56. Accordingly, region 56 acts as a passive or parasitic antenna element with respect to region 54. As a result, the configuration of region 54 and the spacing between regions 54 and 56 are determined by the required antenna pattern radiation from regions 54, 56 as installed on touchscreen antenna system 50.

Additionally, a first trace of conductive material 51, such as copper or aluminum, is disposed on a portion of an FPC substrate 53 and at least partly overlaps region 54, such that first trace 51 capacitively couples to first region of transparent conductive material 54. A second trace of conductive material 55, such as copper or aluminum, is also disposed on FPC substrate 53 and couples to first trace 51. Preferably, first trace 51 and second trace 55 are physically connected. In addition, traces 51 and 55 may couple to a portion of a touch sensor line 57. Thus, traces 51, 55 and line 57 may become part of the feeding mechanism of the antenna element defined by region 54.

In regards to the configuration shown in FIG. 5A, trace 51 is defined by a rectangle of approximately 1 mm in width and 10 mm in length. Likewise, trace 55 and line 57 each has a width of approximately 0.5 mm. Also, gap 58 consists of a 1-mm constant spacing between region 54 and region 56. Unlike region 54, region 56 is not functionally required for operation of touchscreen antenna system 50. However, the absence of region 56 may make region 54 more noticeable to the human eye, because the conductive material forming regions 54, 56 is typically not fully transparent. Thus, preferably, region 56 remains installed to provide a more uniform look of touchscreen antenna system 50.

Typically, gap 58 is defined by a single value ranging from 0.1 mm to 2 mm. In addition, region 54 may be defined by the shape of an edge 59 of region 54, which is contiguous to gap 58. The shape of edge 59 approximately follows a Gaussian curve, wherein the maximum value and standard deviation will depend on the specific application as well-known to those skilled in the art.

Furthermore, the portion of FPC substrate 53, shown in FIG. 5A, is defined by a rectangle of approximately 3 mm in width and 10 mm in length, including the area of region 51 disposed on FPC substrate 53. It should be understood that the width of FPC substrate 53 is generally longer than as shown, because it folds underneath substrate 52 to couple to other components of touchscreen antenna system 50. Preferably, regions 54 and 56 are planar and made of a film of a material such as ITO. However, regions 54 and 56 may also be implemented by means of another conductive material, including a copper mesh and silver nanowires arranged in a linear or a grid pattern to maintain a required optical transparency.

Those skilled in the art will recognize that the dimensions and shape of gap 58, including a variable spacing; traces 51, 55; regions 54, 56; and line 57 may be selected or modified to potentially adjust certain performance parameters of touchscreen antenna system 50, including input impedance, gain, polarization, and antenna efficiency. More specifically, FIG. 5B shows a top view of a touchscreen antenna system 50, as described in reference to FIG. 5A, wherein touch sensor line 57 is coupled to a number of traces 57a, 57b, and 57c. Traces 57a, 57b, 57c may act as a frequency tuning stub, allowing the input impedance of touchscreen antenna system 50 to be adjusted within a range of values to improve the overall antenna performance. In this configuration, traces 57a, 57b, 57c have a width of 0.5 mm and a varying length ranging from 0.5 mm to 1.5 mm. Thus, traces 57a, 57b, 57c of line 57 become part of the feeding mechanism of the antenna element defined by region 54.

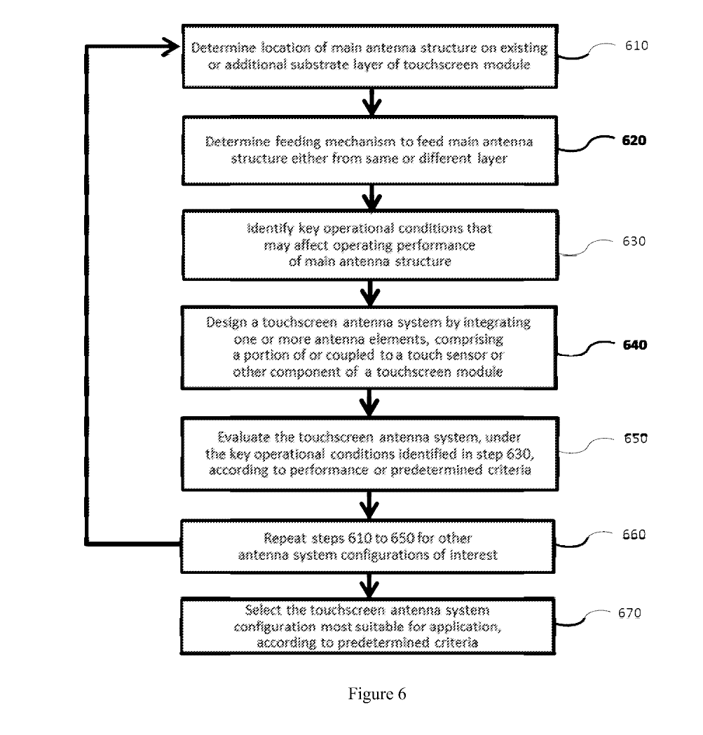

The method of designing a touchscreen antenna system in accordance with certain aspects of an embodiment of the invention defines dimensional and operational parameters of one or more antenna elements and other potential components which may be part of the touchscreen antenna system. These components include electronic components, such as RF filtering elements, electrodes, sensors, controllers, display units, integrated circuits, flexible printed circuits, transmission lines, diodes, switches, resistors, capacitors, and inductors, as well as dielectric magnetic materials, frequency selective surfaces materials to enhance or reduce electromagnetic coupling of such antenna element, and shielding materials, necessary to provide an operational performance of said touchscreen antenna system in a complex surrounding environment for an intended application, as shown in FIG. 6, and according to the following:
1. At step 610, determining a location of a main antenna structure either on an existing substrate layer of a touchscreen module or on an additional substrate layer to be incorporated into the touchscreen module.
2. Next, at step 620, determining a feeding mechanism to feed the main antenna structure either from the same substrate layer wherein the main antenna structure will be disposed on or from a different substrate layer.
3. Next, at step 630, identifying key operational conditions in which the performance of the main antenna structure might be affected. These key operational conditions may include, but are not limited to, the presence of any combination of human user body parts (e.g. hands, fingers, head or other parts of the body as when such device is placed in a pocket or hung on clothing), conductive materials, or dielectric materials located within a radius of two wavelengths at the lowest frequency of operation in the medium where said antenna element is operating.
4. Next, at step 640, creating an electromagnetic model, for each key operational condition identified in step 630, to characterize and improve the antenna system performance after completing one or more of the following:
   4.1 Designing one or more main antenna elements, wherein each main antenna element is formed by a first section, comprising a portion of a touch sensor; a second section, comprising a complementary antenna portion, either physically or electromagnetically coupled to the first section; and a third section, comprising an antenna feeding mechanism, either physically or electromagnetically coupled to the second section.
   4.2 Designing one or more main antenna elements, wherein each main antenna element is formed by a first section, comprising a primary antenna portion disposed on an area adjacent to a touch sensor; a second section, comprising a complementary antenna portion, either physically or electromagnetically coupled to the first section; and a third section comprising an antenna feeding mechanism, either physically or electromagnetically coupled to the second section.
   4.3 Improving key performance parameters, including gain, radiation efficiency, polarization, and input impedance, of one or more main antenna elements, based on a statistical distribution of theoretical and or experimental data corresponding to different operational conditions.
   4.4 Designing a touchscreen antenna system, comprising one or more main antenna elements; touch sensors either physically or electromagnetically coupled to one or more main antenna elements; integrated circuits; and other conductive and dielectric materials forming part of the touchscreen module, operating in combination with such touchscreen module.
5. Next, at step 650, evaluating the operation of the touchscreen antenna system, according to performance or other criteria, requirements, and each key operational condition identified in step 630.
6. Next, at step 660, repeating steps 610 to 650, if necessary, for other configurations of the touchscreen antenna system.
7. Last, at step 670, selecting the most suitable configuration of the touchscreen antenna system (dimensional and operational parameters of each antenna element and other components of the antenna system) for the intended application, in terms of performance or other predetermined criteria.

Those skilled in the art will recognize that the steps above indicated can be correspondingly adjusted for specific antenna configurations and other constraints such as antenna system and touchscreen sensors dimensions; conformality; type, number, and location of touch sensors and associated electrodes; obtrusiveness; operating frequency;

bandwidth; operational conditions; and surrounding environment as well as available area and location for implementation of the antenna system for each particular application. In particular, a variety of touch sensors, such as capacitive, resistive, acoustic, and force sensors, may be used as one of the touchscreen elements.

Preferably, the determination of the dimensional and operational parameters of the antenna element and other components of the touchscreen antenna system, the creation of electromagnetic models, and the evaluation and improvement of key performance parameters of the touchscreen antenna system, including but not limited to electromagnetic fields, radiation efficiency, currents, radiation gain patterns, input impedance, and polarization are performed by means of a computer-assisted simulation tool and electromagnetic simulation software, such as Ansys-HFSS commercial software or other methods well-known by those skilled in the art.

The method and various embodiments have been described herein in an illustrative manner, and it is to be understood that the terminology used is intended to be in the nature of words of description rather than of limitation. Any embodiment herein disclosed may include one or more aspects of the other embodiments. The exemplary embodiments were described to explain some of the principles of the present invention so that others skilled in the art may practice the invention. Obviously, many modifications and variations of the invention are possible in light of the above teachings. The present invention may be practiced otherwise than as specifically described within the scope of the appended claims and their legal equivalents.

I claim:

1. A touchscreen antenna system, comprising:
a touchscreen that includes a plurality of substrates;
an antenna element disposed on one of said substrates of said plurality of substrates;
a touchscreen element disposed on one of said substrates of said plurality of substrates; and
a transmission line coupled to said antenna element;
wherein said antenna element is coupled to said touchscreen element such that said touchscreen element modifies an operational performance of said antenna element to enable a functionality of said touchscreen antenna system for an intended application at a first frequency band of operation; and wherein said antenna element and said touchscreen element are configured such that an input impedance at said touchscreen antenna system substantially matches an input impedance of said transmission line coupled to said antenna element.

2. The system of claim 1, further comprising a flexible printed circuit, wherein said antenna element is coupled to said flexible printed circuit.

3. The system of claim 2, wherein said flexible printed circuit comprises an antenna feeding mechanism and said antenna element comprises an active radiation element.

4. The system of claim 2, wherein said flexible printed circuit is at least partly disposed on a second substrate of said plurality of substrates.

5. The system of claim 1, further comprising a flexible printed circuit, wherein said antenna element is disposed on said flexible printed circuit.

6. The system of claim 1, wherein said antenna element comprises a metal compound that is at least partly electrically conductive.

7. The system of claim 1, wherein said antenna element comprises a plurality of nanowires.

8. The system of claim 1, wherein said antenna element further comprises at least one of the following elements:
1) an active radiation element;
2) a passive radiation element; and
3) an antenna feeding element.

9. The system of claim 8, wherein said touchscreen element is fed by said antenna element and said touchscreen element is used as an active radiation element of said system.

10. The system of claim 1, wherein said touchscreen element is used as a feeding mechanism of an active radiation element.

11. The system of claim 1, wherein said touchscreen element comprises at least one item selected from the group consisting of:
an active touchscreen element;
a passive touchscreen element;
a touch sensor line;
a display unit; and
a touch controller.

12. The system of claim 1, wherein said touchscreen further comprises a plurality of touchscreen elements in at least one substrate of said plurality of substrates.

13. The system of claim 12, wherein at least one of said plurality of touchscreen elements is used as a passive radiation element of said system.

14. The system of claim 1, wherein said antenna element is capacitively coupled to said touchscreen element.

15. The system of claim 1, wherein said antenna element comprises an adaptive feeding section according to a shape and size of said touchscreen element.

16. The system of claim 1, wherein said touchscreen element is shaped and sized to control a degree of coupling between said antenna element and said touchscreen element.

17. The system of claim 16, wherein said touchscreen element comprises a section to enable a frequency tuning of an input impedance of said system.

18. The system of claim 17, wherein said touchscreen element comprises a section having a semi-elliptical configuration.

19. The system of claim 1, wherein said antenna element is disposed on a second substrate of said plurality of substrates.

20. The system of claim 1, wherein said antenna element and said touchscreen element are made of the same material.

21. The system of claim 1, wherein said touchscreen comprises at least one item selected from the group consisting of:
a capacitive touch sensor;
a resistive touch sensor;
an acoustic touch sensor; and
a force touch sensor.

22. The system of claim 1, wherein said system operates at a plurality of frequency bands of operation.

23. The system of claim 1, wherein said antenna element is implemented by means of at least a section of said transmission line.

24. The system of claim 1, further comprising a feeding element coupled to a section of said transmission line.

25. The system of claim 1, wherein said antenna element comprises a coplanar waveguide.

26. The system of claim 1, further comprising an impedance matching network.
